(19) United States
(12) Patent Application Publication
(10) Pub. No.: US 2022/0332107 A1
(43) Pub. Date: Oct. 20, 2022

(54) AUXILIARY DEVICE FOR STICKING OF TEMPERED GLASS SCREEN PROTECTOR AND TEMPERED GLASS SCREEN PROTECTOR COMBINATION

(71) Applicant: Canzhong Du, Shenzhen (CN)

(72) Inventor: Canzhong Du, Shenzhen (CN)

(21) Appl. No.: 17/855,812

(22) Filed: Jul. 1, 2022

(30) Foreign Application Priority Data
May 16, 2022 (CN) 202221159350.9

(51) Int. Cl. B32B 38/18; B32B 37/00; B32B 17/06; B32B 7/06; B32B 7/12; B32B 15/18; B32B 37/18; B32B 37/26

(52) U.S. Cl. CPC B32B 38/1841; B32B 37/0046; B32B 17/06; B32B 7/06; B32B 7/12; B32B 15/18; B32B 37/18; B32B 37/26; B32B 2571/00; B32B 2307/208; B32B 2315/08; B32B 2457/20; B32B 2037/268; B32B 2307/748

(57) ABSTRACT

The present disclosure provides an auxiliary device for sticking of a tempered glass screen protector and a tempered glass screen protector combination. The auxiliary device includes a sticking limiting frame made of a plastic material; a sticking area of the sticking limiting frame is matched with the appearance of a screen of a product to be covered; each of four edges of a back surface of the sticking limiting frame is at least provided with one stepped limiting slot; each stepped limiting slot includes a product limiting slot and a tempered glass screen protector limiting slot; and one or more magnetic patches are fixed on the sticking area or the back surface.

### TECHNICAL FIELD

The present disclosure relates to portable electronic auxiliary equipment, more specifically to an auxiliary device for sticking of a tempered glass screen protector and a tempered glass screen protector combination.

### BACKGROUND

For a portable electronic device with a screen, such as a mobile phone and a tablet, the screen is easily scratched during use, and a scratch affects the display effect and beauty of the screen. In order to effectively protect a screen, after purchasing a product, a user usually sticks a layer of transparent screen protector to a screen, especially a tempered glass screen protector, so as to protect the screen from being scratched.

Current sticking a screen protector is mainly achieved by manual alignment; a release film under a tempered glass screen protector is torn off; and one side of the tempered glass screen protector is stuck to a screen of an electronic product. The sticking can only be completed by experienced and skilled people. However, the manual alignment depends on human intuition and eye measurement. It is difficult to achieve accurate alignment between a mobile phone screen protector and a mobile phone screen during sticking. Therefore, during sticking, it takes a lot of time to slowly adjust the positions of the mobile phone screen protector and the mobile phone screen, and this operation is troublesome and a waste of time. In order to improve this problem, some devices for assisting sticking had also been provided before, such as Patent: The precedent patent of a screen protector sticking device (with patent number of 201620279935.2) provides auxiliary equipment for screen protector sticking, which is used for improving the quality and efficiency of sticking. The positioning is mainly achieved by a positioning frame. A tempered glass screen protector is connected to the positioning frame by gluing, and a sticker is then torn off. However, the auxiliary device has the following problems. A difference between the position of a tempered glass screen protector and the position of a screen of electronic equipment is not considered. Actually, the alignment is inaccurate. If the screen protector is stuck to the screen by gluing, a sticker may be torn up, which will destroy the integrity of the auxiliary equipment, and thus, the auxiliary equipment cannot be repeatedly used.

### SUMMARY

The technical problem to be solved in the present disclosure is how to provide an auxiliary device for sticking which features accurate locating and can be repeatedly used, so as to help ordinary users achieve high-quality self-sticking.

In order to solve the above problem, the present disclosure provides an auxiliary device for sticking of a tempered glass screen protector, including a sticking limiting frame made of a plastic material; a sticking area of the sticking limiting frame is matched with the appearance of a screen of a product to be covered; each of four edges of a back surface of the sticking limiting frame is at least provided with one stepped limiting slot; each stepped limiting slot includes a product limiting slot and a tempered glass screen protector limiting slot; by the product limiting slots on the four edges, a product to be covered is located on the sticking limiting frame; by the tempered glass screen protector limiting slots on the four edges, a tempered glass screen protector is located on the sticking limiting frame, so that a relative position between the tempered glass screen protector and a screen of the product to be covered is fixed; an internal position encircled by the tempered glass screen protector limiting slots on the four edges is a flat sticking area; and one or more magnetic patches are fixed on the sticking area or the back surface.

According to the auxiliary device for sticking of the tempered glass screen protector, wherein at least one recessed iron sheet or magnetic patch embedding slot is formed in the sticking area.

According to the auxiliary device for sticking of the tempered glass screen protector, a bottom surface or a back surface of the iron sheet or magnetic patch embedding slot is provided with one or more matching magnetic patch embedding slots; a magnetic patch or an iron sheet is arranged in each matching magnetic patch embedding slot; and a decorative sticker is covered on the matching magnetic patch embedding slot.

According to the auxiliary device for sticking of the tempered glass screen protector, a height of each tempered glass screen protector limiting slot is slightly greater than a thickness of the tempered glass screen protector to be used.

According to the auxiliary device for sticking of the tempered glass screen protector, one penetrating pick-up through hole is formed in the sticking area.

According to the auxiliary device for sticking of the tempered glass screen protector, six tempered glass screen protector limiting slots are provided from top to bottom, specifically including a first tempered glass screen protector limiting slot, a second tempered glass screen protector limiting slot, a third tempered glass screen protector limiting slot, a fourth tempered glass screen protector limiting slot, a fifth tempered glass screen protector limiting slot and a sixth tempered glass screen protector limiting slot; the first tempered glass screen protector limiting slot is arranged in the middle of the upper edge; the second tempered glass screen protector limiting slot and the third tempered glass screen protector limiting slot are symmetrically arranged at the upper middle parts of the left and right sides; the fourth tempered glass screen protector limiting slot and the fifth tempered glass screen protector limiting slot are symmetrically arranged at the lower middle parts of the left and right sides; the sixth tempered glass screen protector limiting slot is arranged in the middle of the lower edge; the fourth tempered glass screen protector limiting slot and the fifth tempered glass screen protector limiting slot have equal heights which are less than a height of the sixth tempered glass screen protector limiting slot; the second tempered glass screen protector limiting slot and the third tempered glass screen protector limiting slot have equal heights which are less than the height of the fourth tempered glass screen protector limiting slot; and the height of the first tempered glass screen protector limiting slot is less than that of the second tempered glass screen protector limiting slot.

A tempered glass screen protector combination includes a tempered glass screen protector, and a protective film and a release film which are arranged on two sides of the tempered glass screen protector, wherein the protective film is also glued, through a glue layer, with a matching magnetic patch or a matching iron sheet that achieves magnetic attraction with the magnetic patch or iron sheet provided on the auxiliary device for sticking of a tempered glass screen protector.

According to the tempered glass screen protector combination, the appearance of the matching magnetic patch or matching iron sheet is matched with the iron sheet or magnetic patch embedding slot on the auxiliary device for sticking of a tempered glass screen protector; and the overall size is less than that of the iron sheet or magnetic patch embedding slot.

The implementation of the present disclosure has the following beneficial effects: By simply adding an iron sheet or a magnetic patch on an existing tempered glass screen protector combination, the auxiliary device for sticking of a tempered glass screen protector accurately locates the product to be covered and the tempered glass screen protector to achieve accurate locating and sticking; after the sticking is completed, a protective film with the iron sheet or magnetic patch is torn off, so that the sticking quality is high, and the operation is flexible and convenient. The auxiliary device for sticking of a tempered glass screen protector that is taken down is intact and can be repeatedly used.

### BRIEF DESCRIPTION OF THE DRAWINGS

FIG. 1 is an overall schematic three-dimensional diagram of a sticking limiting frame;

FIG. 2 is an exploded diagram of an auxiliary device for sticking of a tempered glass screen protector;

FIG. 3 is an exploded diagram of a tempered glass screen protector combination;

FIG. 4 is a schematic diagram of cooperation of a tempered glass screen protector combination and an auxiliary device for sticking of a tempered glass screen protector.

### DETAILED DESCRIPTION OF THE EMBODIMENTS

The technical solutions in the embodiments of the present disclosure will be described clearly and completely below with reference to the drawings in the embodiments of the present disclosure. Obviously, the embodiments described herein are only part of the embodiments of the present disclosure, not all the embodiments. Based on the embodiments in the present disclosure, all other embodiments obtained by those of ordinary skill in the art without creative work shall fall within the protection scope of the present disclosure.

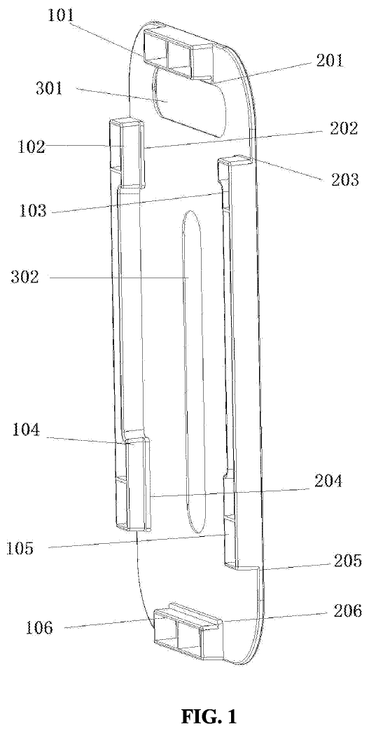

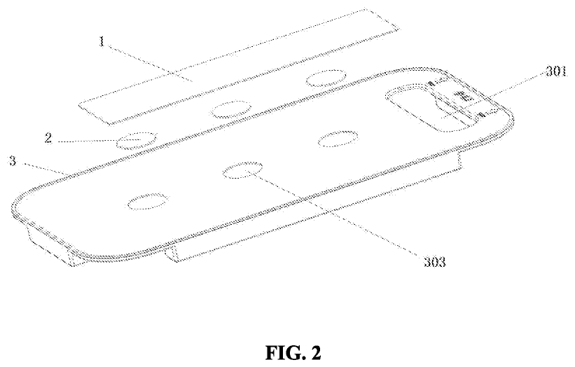

FIG. 1 is an overall schematic three-dimensional diagram of a sticking limiting frame, and FIG. 2 is an exploded diagram of an auxiliary device for sticking of a tempered glass screen protector.

A sticking limiting frame is a core component of the auxiliary device for sticking of a tempered glass screen protector. A sticking area of the sticking limiting frame is matched with the appearance of a screen of a product to be covered. An embodiment matched with a mobile phone product is illustrated. The appearances of different brands can be adjusted according to an actual product. If one product to be covered is determined, positions of a tempered glass screen protector and a screen of the product to be covered are also determined. Therefore, positions of stepped limiting slots are set according to the product to be covered. Each of four edges of a back surface of the sticking limiting frame is at least provided with one stepped limiting slot. Each stepped limiting slot includes a product limiting slot and a tempered glass screen protector limiting slot; by the product limiting slots, the product to be covered is located on the sticking limiting frame; by the tempered glass screen protector limiting slots, the tempered glass screen protector is located on the sticking limiting frame, so that a relative position between the tempered glass screen protector and a screen of the product to be covered is fixed. An internal position encircled by the tempered glass screen protector limiting slots on the four edges is a flat sticking area. In this embodiment, six tempered glass screen protector limiting slots and six product limiting slots are provided. The product limiting slots specifically include a first product limiting slot 101, a second product limiting slot 102, a third product limiting slot 103, a fourth product limiting slot 104, a fifth product limiting slot 105 and a sixth product limiting slot 106. The first product limiting slot 101, the second product limiting slot 102, the third product limiting slot 103, the fourth product limiting slot 104, the fifth product limiting slot 105 and the sixth product limiting slot 106 are combined together to form a limiting slot adapting to a peripheral size of an electronic product. The tempered glass screen protector limiting slots specifically include a first tempered glass screen protector limiting slot 201, a second tempered glass screen protector limiting slot 202, a third tempered glass screen protector limiting slot 203, a fourth tempered glass screen protector limiting slot 204, a fifth tempered glass screen protector limiting slot 205 and a sixth tempered glass screen protector limiting slot 206. The first tempered glass screen protector limiting slot 201, the second tempered glass screen protector limiting slot 202, the third tempered glass screen protector limiting slot 203, the fourth tempered glass screen protector limiting slot 204, the fifth tempered glass screen protector limiting slot 205 and the sixth tempered glass screen protector limiting slot 206 form a limiting slot adapting to a peripheral size of the tempered glass screen protector, that is, the sticking area. Preferably, the first tempered glass screen protector limiting slot is arranged in the middle of the upper edge; the second tempered glass screen protector limiting slot and the third tempered glass screen protector limiting slot are symmetrically arranged at the upper middle parts of the left and right sides; the fourth tempered glass screen protector limiting slot and the fifth tempered glass screen protector limiting slot are symmetrically arranged at the lower middle parts of the left and right sides; the sixth tempered glass screen protector limiting slot is arranged in the middle of the lower edge; the fourth tempered glass screen protector limiting slot and the fifth tempered glass screen protector limiting slot have equal heights which are less than a height of the sixth tempered glass screen protector limiting slot; the second tempered glass screen protector limiting slot and the third tempered glass screen protector limiting slot have equal heights which are less than the height of the fourth tempered glass screen protector limiting slot; and the height of the first tempered glass screen protector limiting slot is less than that of the second tempered glass screen protector limiting slot. One or more recessed iron sheet or magnetic patch embedding slots 302 can be selectively provided on the sticking area. In this embodiment, the embedding slot is a rectangular or elliptical groove or may be in other shapes. One or more magnetic patches are fixed at a bottom or a back surface of each iron sheet or magnetic patch embedding slot. In this embodiment, a magnetic patch or an iron sheet is selected. In this embodiment, three circular matching magnetic patch embedding slots 303 are uniformly formed in the back surface of the iron sheet or magnetic patch embedding slot; magnetic patches 2 are arranged in the matching magnetic patch embedding slots. A decorative sticker 1 is covered on each matching magnetic patch embedding slot for beauty.

As an optimization, there is a height difference among the first tempered glass screen protector limiting slot 201, the second tempered glass screen protector limiting slot 202, the third tempered glass screen protector limiting slot 203, the fourth tempered glass screen protector limiting slot 204, the fifth tempered glass screen protector limiting slot 205 and the sixth tempered glass screen protector limiting slot 206, so that the tempered glass screen protector and a surface of the screen of the electronic product form an included angle during sticking. Since the first tempered glass screen protector limiting slot 201 is lowest, the tempered glass screen protector on this side is first stuck to the screen of the electronic product and is then automatically stuck towards the sixth tempered glass screen protector limiting slot 206 until the entire tempered glass screen protector is completely stuck to the screen of the electronic product. An air discharge direction of sticking is determined to avoid a bubbling problem caused by disordered air discharge.

A penetrating pick-up through hole 301 is formed in the sticking area, so as to facilitate separating the auxiliary device for sticking of a tempered glass screen protector after the sticking is completed.

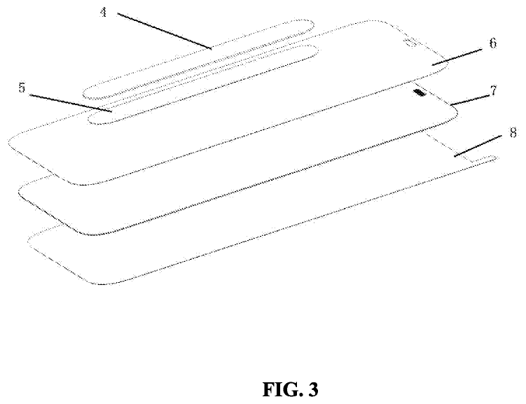

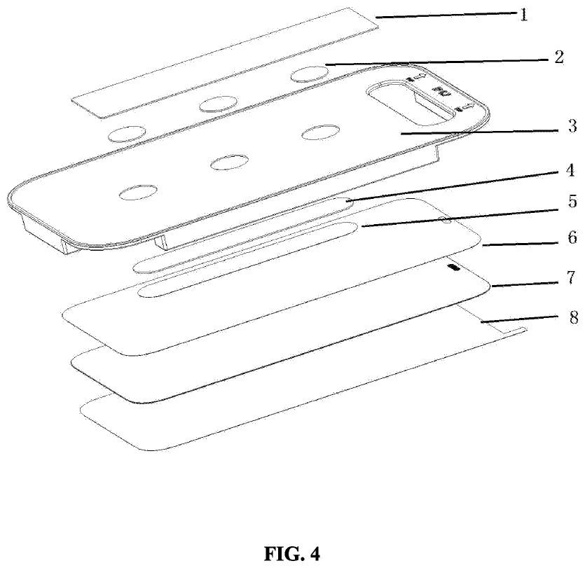

FIG. 3 is an exploded diagram of a tempered glass screen protector combination, and FIG. 4 is a schematic diagram of cooperation of a tempered glass screen protector combination and an auxiliary device for sticking of a tempered glass screen protector. The tempered glass screen protector combination is a specific tempered glass screen protector combination designed to be completely matched with the auxiliary device for sticking of a tempered glass screen protector, and includes a tempered glass screen protector 7, and a protective film 6 and a release film 8 which are arranged on two sides of the tempered glass screen protector. The protective film is also glued with an iron sheet layer 4 through a glue layer 5. The iron sheet layer is selected for illustration for a matching magnetic patch or a magnetic iron sheet. The appearance of the iron sheet layer is matched with the iron sheet or magnetic patch embedding slot on the auxiliary device for sticking of a tempered glass screen protector, and the overall size is less than that of the iron sheet or magnetic patch embedding slot. The thickness of the iron sheet layer is slightly greater than a depth of the iron sheet or magnetic patch embedding slot.

A specific sticking process is as follows. First, the entire tempered glass screen protector combination is placed in the sticking area of the auxiliary device for sticking of a tempered glass screen protector. The iron sheet layer on the tempered glass screen protector combination is aligned with the iron sheet or magnetic patch embedding slot and is fixed in a limiting position under the magnetic attraction of the magnetic patch. The release film 8 is then torn off. The entire auxiliary device for sticking of a tempered glass screen protector is covered on a surface of the screen of the electronic product. There is a height difference among the first tempered glass screen protector limiting slot 201, the second tempered glass screen protector limiting slot 202, the third tempered glass screen protector limiting slot 203, the fourth tempered glass screen protector limiting slot 204, the fifth tempered glass screen protector limiting slot 205 and the sixth tempered glass screen protector limiting slot 206, so that the tempered glass screen protector combination and the surface of the screen of the electronic product form an included angle. Since the first tempered glass screen protector limiting slot 201 is lowest, the tempered glass screen protector on this side is first stuck to the screen of the electronic product and is then automatically stuck towards the sixth tempered glass screen protector limiting slot 206 until the entire tempered glass screen protector is completely stuck to the screen of the electronic product. The tempered glass screen protector combination is pressed with a finger through the pick-up through hole 301 to take out the auxiliary device for sticking of the tempered glass screen protector. The protective film 6 with the iron sheet 4 is torn off, completing the sticking. The entire operation is flexible and convenient. The auxiliary device for sticking of the tempered glass screen protector that is taken down is intact. When it is needed, a new tempered glass screen protector combination is used for replacing the old combination. The auxiliary device for sticking of the tempered glass screen protector is repeatedly used.

What is disclosed above is only one embodiment of the present disclosure, and of course, the scope of the claims of the present disclosure cannot be limited by this. Those of ordinary skill in the art can understand that all or part of the process of implementing the above-mentioned embodiment and equivalent changes made according to the claims of the present disclosure still fall within the scope covered by the present disclosure.

What is claimed is:

1. An auxiliary device for sticking of a tempered glass screen protector, comprising a sticking limiting frame made of a plastic material, wherein each of four edges of a back surface of the sticking limiting frame is at least provided with one stepped limiting slot; each stepped limiting slot comprises a product limiting slot and a tempered glass screen protector limiting slot; by the product limiting slots on the four edges, a product to be covered is located on the sticking limiting frame; by the tempered glass screen protector limiting slots on the four edges, a tempered glass screen protector is located on the sticking limiting frame, so that a relative position between the tempered glass screen protector and a screen of the product to be covered is fixed; an internal position encircled by the tempered glass screen protector limiting slots on the four edges is a flat sticking area; and one or more magnetic patches are fixed on the sticking area or the back surface.

2. The auxiliary device for sticking of the tempered glass screen protector according to claim 1, wherein at least one recessed iron sheet or magnetic patch embedding slot is formed in the sticking area.

3. The auxiliary device for sticking of the tempered glass screen protector according to claim 2, wherein a bottom surface or a back surface of the iron sheet or magnetic patch embedding slot is provided with one or more matching magnetic patch embedding slots; a magnetic patch or an iron sheet is arranged in each matching magnetic patch embedding slot; and a decorative sticker is covered on the matching magnetic patch embedding slot.

4. The auxiliary device for sticking of the tempered glass screen protector according to claim 1, wherein a height of each tempered glass screen protector limiting slot is slightly greater than a thickness of the tempered glass screen protector to be used.

5. The auxiliary device for sticking of the tempered glass screen protector according to claim 1, wherein one penetrating pick-up through hole is formed in the sticking area.

6. The auxiliary device for sticking of the tempered glass screen protector according to claim 1, wherein six tempered glass screen protector limiting slots are provided from top to bottom, specifically comprising a first tempered glass screen protector limiting slot, a second tempered glass screen protector limiting slot, a third tempered glass screen protector limiting slot, a fourth tempered glass screen protector limiting slot, a fifth tempered glass screen protector limiting slot and a sixth tempered glass screen protector limiting slot; the first tempered glass screen protector limiting slot is arranged in the middle of the upper edge; the second tempered glass screen protector limiting slot and the third tempered glass screen protector limiting slot are symmetrically arranged at the upper middle parts of the left and right sides; the fourth tempered glass screen protector limiting slot and the fifth tempered glass screen protector limiting slot are symmetrically arranged at the lower middle parts of the left and right sides; the sixth tempered glass screen protector limiting slot is arranged in the middle of the lower edge; the fourth tempered glass screen protector limiting slot and the fifth tempered glass screen protector limiting slot have equal heights which are less than a height of the sixth tempered glass screen protector limiting slot; the second tempered glass screen protector limiting slot and the third tempered glass screen protector limiting slot have equal heights which are less than the height of the fourth tempered glass screen protector limiting slot; and the height of the first tempered glass screen protector limiting slot is less than that of the second tempered glass screen protector limiting slot.

7. A tempered glass screen protector combination, comprising a tempered glass screen protector, and a protective film and a release film which are arranged on two sides of the tempered glass screen protector, wherein the protective film is also glued, through a glue layer, with a matching magnetic patch or a matching iron sheet that achieves magnetic attraction with the magnetic patch or iron sheet provided on the auxiliary device for sticking of a tempered glass screen protector according to claim 1.

8. The tempered glass screen protector combination according to claim 7, wherein the appearance of the matching magnetic patch or matching iron sheet is matched with the iron sheet or magnetic patch embedding slot on the auxiliary device for sticking of a tempered glass screen protector according to claim 2; and the overall size is less than that of the iron sheet or magnetic patch embedding slot.
